(19) United States
(12) Patent Application Publication
(10) Pub. No.: US 2013/0167712 A1
(43) Pub. Date: Jul. 4, 2013

(54) CYLINDER

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HUAN-FAN XU, Shenzhen (CN); JUN HE, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/726,541

(22) Filed: Dec. 25, 2012

(30) Foreign Application Priority Data
Dec. 29, 2011 (CN) 201110450529.X

(51) Int. Cl. F15B 15/06

(52) U.S. Cl. CPC F15B 15/063
USPC 92/31

(57) ABSTRACT

A cylinder includes a cylinder body assembly, a piston assembly, and a cylinder rod. The cylinder body assembly includes a cylinder body with an inlet and an outlet. The piston assembly includes a piston that is capable of moving axially and a rotation pin. A helical rotation groove is defined in the cylinder rod. The piston is sleeved on the cylinder rod via the rotation pin. One end of the rotation pin is connected to the piston, and the other end of the rotation pin is located in the rotation groove, such that the cylinder rod is rotatable in the piston.

### BACKGROUND

1. Technical Field

The present disclosure relates to cylinders, and particularly to a cylinder capable of sliding and rotating.

2. Description of Related Art

A push rod of a cylinder transports and positions a workpiece, and drives other devices. A cylinder may include a cylinder body defining a receiving chamber, a piston and a push rod received in the receiving chamber. The cylinder body may define two openings at opposite ends communicating with the receiving chamber. The piston may be movably received in the receiving chamber, one end of the push rod may be fixed to the piston, and the other end of the push rod may extend out of the cylinder body via one opening of the cylinder body. The push rod transports or positions a workpiece. However, the push rod is only capable of sliding back and forth, but when radial rotation is required, the above-described cylinder cannot meet such motion requirement.

Therefore, there is room for improvement in the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an exploded, isometric view of an embodiment of a cylinder.

FIG. 2 is similar to FIG. 1, but viewed from another aspect.

FIG. 3 is an assembled, isometric view of the cylinder shown in FIG. 1.

FIG. 4 is a cutaway view of the cylinder of FIG. 1 operating in a first state.

FIG. 5 is a cutaway view of the cylinder of FIG. 1 operating in a second state.

### DETAILED DESCRIPTION

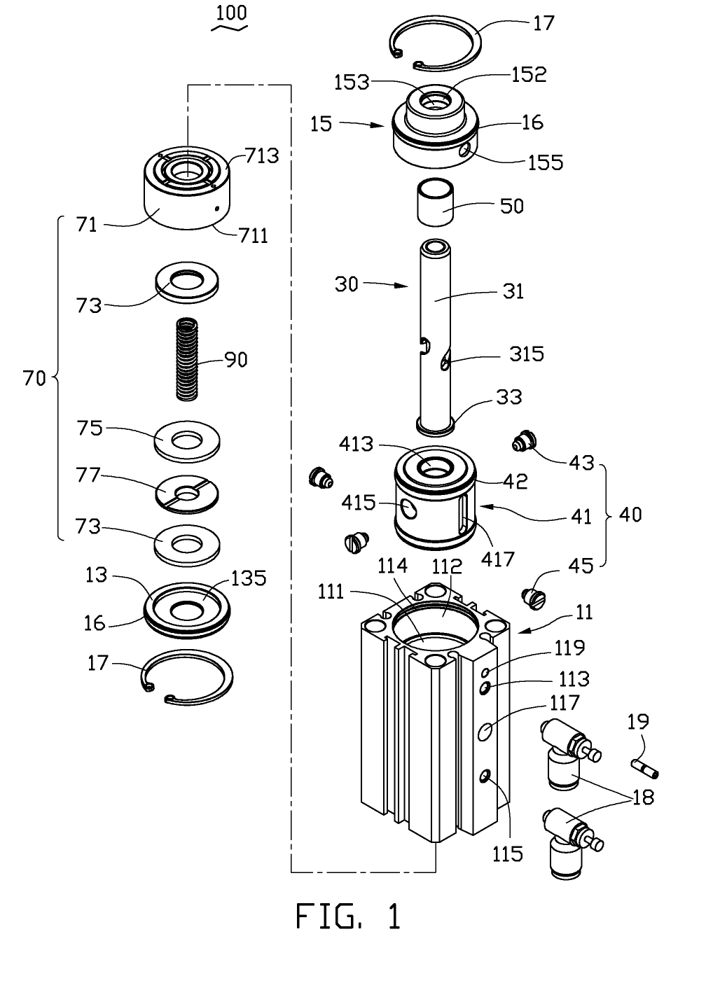

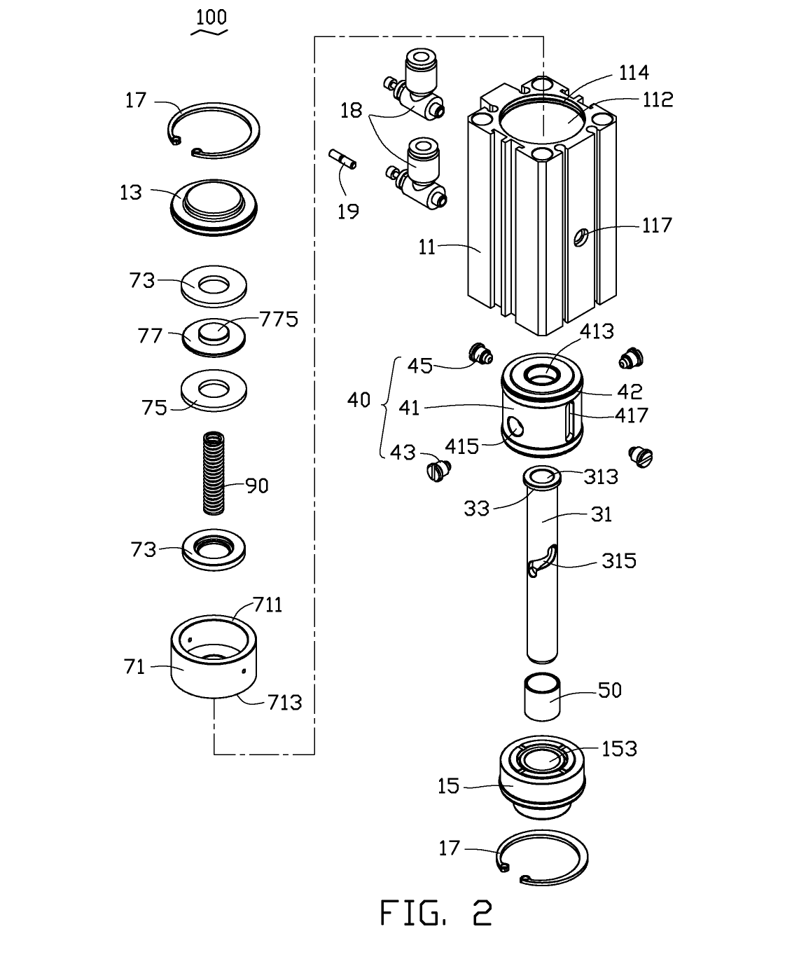

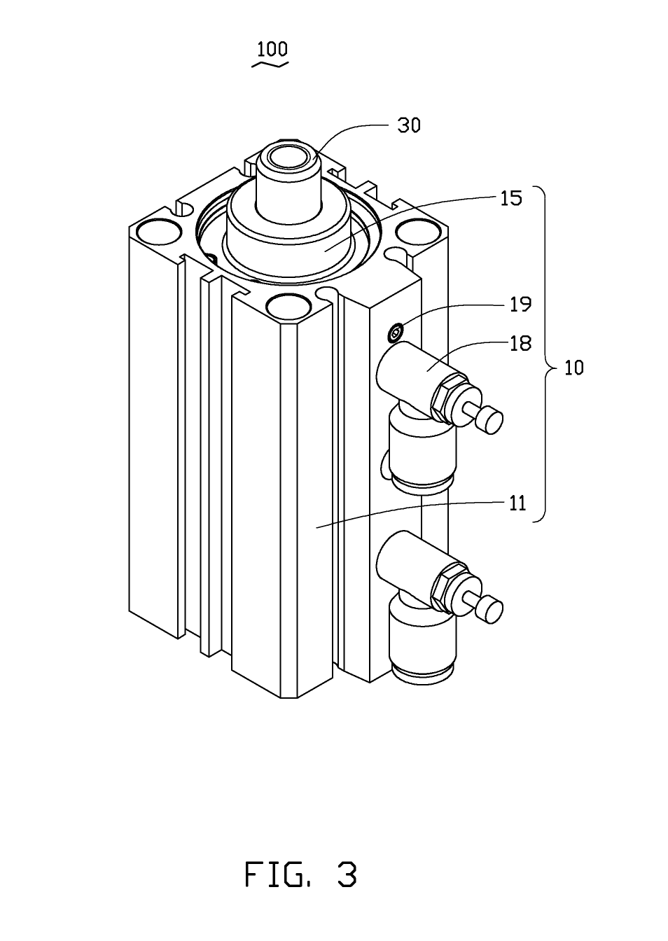

FIGS. 1 through 3 show an embodiment of a cylinder 100. The cylinder 100 includes a cylinder body assembly 10, a cylinder rod 30, a piston assembly 40, a guiding sleeve 50, a connection assembly 70, and an elastic member 90. The cylinder rod 30 is movably mounted in the cylinder body assembly 10. The piston assembly 40 is sleeved on the cylinder rod 30, and is movably assembled within the cylinder body assembly 10 and the cylinder rod 30. The guiding sleeve 50 and the connection assembly 70 are mounted in opposite ends of the cylinder body assembly 10, and are sleeved on opposite ends of the cylinder rod 30. The elastic member 90 is mounted in the cylinder body assembly 10. The elastic member 90 is installed between the connection assembly 70 and one end of the cylinder rod 30 adjacent to the connection assembly 70, such that the cylinder rod 30 and the cylinder body assembly 10 are mounted together in line with the central axis of the cylinder 100.

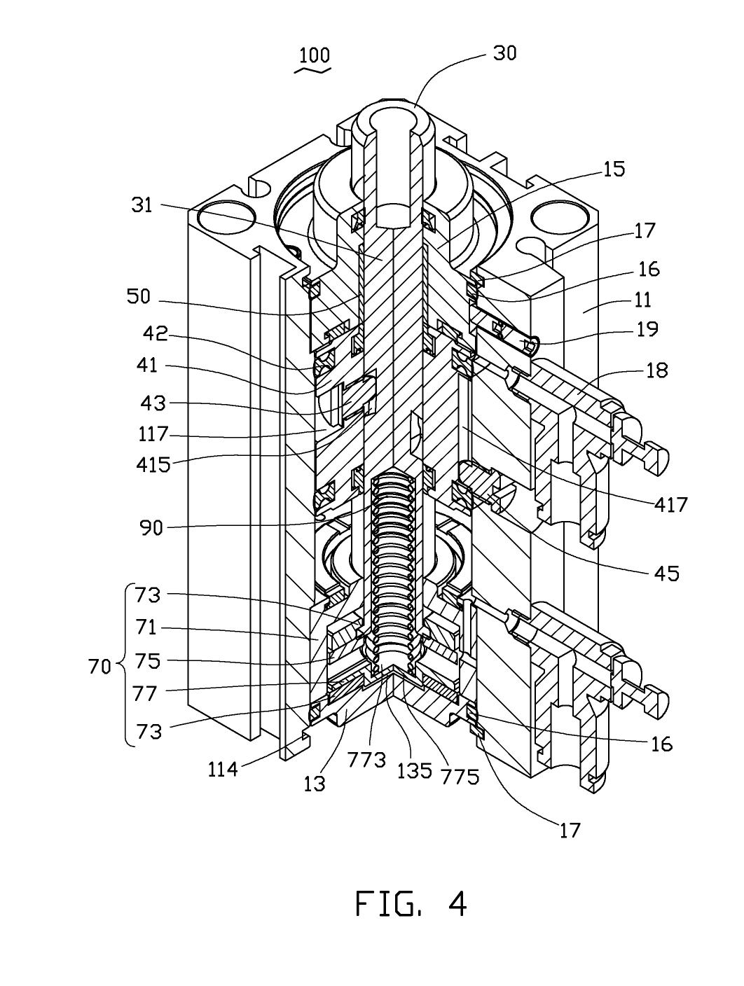

Referring also to FIG. 4, the cylinder body assembly 10 includes a cylinder body 11, a bottom cover 13, a top cover 15, two sealing washers 16, two latching rings 17, two adjusting valves 18, and a fixing member 19. A receiving hole 111 surrounds the central axis of the cylinder body 11. An inlet 113 and an outlet 115 are defined in an outer wall of the cylinder body 11, communicating with the receiving hole 111. The inlet 113 and the outlet 115 are connected to two gas sources (not shown) via the two adjusting valves 18, for introducing gases into the cylinder body 11, such that the pressure of the gases causes the piston assembly 40 and the cylinder rod 30 mounted in the cylinder body assembly 10 to move. Two annular mounting grooves 112 are defined in an inner wall of the cylinder body 11 at opposite ends of the receiving hole 111. The annular mounting grooves 112 are substantially ring-shaped and coaxial with the receiving hole 111. An annular latching groove 114 is defined in an inner wall of each annular mounting groove 112 adjacent to one end of the cylinder body 11. Two connecting holes 117 are defined symmetrically in the outer wall of the cylinder body 11, communicating with the receiving hole 111. One of the connecting holes 117 is defined between the inlet 113 and the outlet 115. A fixing hole 119 is defined in the outer wall of the cylinder body 11 adjacent to one end thereof, communicating with one annular mounting groove 112. In the illustrated embodiment, the cylinder body 11 is substantially rectangular in outline, and hollow. The inlet 113, the outlet 115, one of the connecting holes 117, and the fixing hole 119, are positioned in a straight line parallel to the central axis of the cylinder body 11.

The bottom cover 13 is received in one annular mounting groove 112 away from the fixing hole 119, and one sealing washer 16 is received in the annular mounting groove 112 below the bottom cover 13, such that one end of the cylinder body 11 is sealed by the bottom cover 13 and the sealing washer 16. A mounting groove 135 is defined axially in the bottom cover 13. The mounting groove 135 is stepped and ring-shaped. The top cover 15 is stepped, hollow, and substantially cylindrical. A shaft hole 152 is axially defined in a center portion of the top cover 15. An annular mounting groove 153 is defined in an inner wall of the top cover 15 at one end of the shaft hole 152. The annular mounting groove 153 is coaxial with the shaft hole 152, for receiving the guiding sleeve 50. A positioning hole 155 is defined in an outer wall of the end of the top cover 15 defining the annular mounting groove 153. The other end of the cylinder body 11 defining the fixing hole 119 is covered by the top cover 15 and the other sealing washer 16 in a similar manner. The fixing member 19 passes through the fixing hole 119 and the positioning hole 155, for fixing the top cover 15 to the cylinder body 11, such that the top cover 15 is fixed in the axial direction of the cylinder body 11. Each of the latching rings 17 is C-shaped, and latches in the annular latching groove 114. The bottom cover 13 and the top cover 15 are kept in place by the two latching rings 17, for preventing the bottom cover 13 and the top cover 15 from sliding out from the cylinder body 11. The two adjusting valves 18 communicate with the cylinder body 11, via the inlet 113 and the outlet 115, and with two gas sources to introduce gases into the cylinder body 11.

The cylinder rod 30 includes a rod body 31 and a flange portion 33 extending from one end of the rod body 31. The rod body 31 is substantially cylindrical. Opposite ends of the rod body 31 are hollow. A mounting hole 313 is defined in an end surface of rod body 31 adjacent to the flange portion 33 along an axial direction thereof. The mounting hole 313 is substantially circular. Two rotation grooves 315 are symmetrically defined in a middle portion of an outer wall of the rod body 31. Each rotation groove 315 is arcuate. In the illustrated embodiment, each rotation groove 315 extends through an angle of substantially 90 degrees along a circular path, such that the cylinder rod 30 is capable of peripheral rotation through 90 degrees relative to the piston assembly 40.

The piston assembly 40 includes a piston 41, two mounting rings 42, two rotation pins 43, and two sliding pins 45. The piston 41 is sleeved on the rod body 31 of the cylinder rod 30, and is movably assembled with the cylinder body 11 and the cylinder rod 30. The piston 41 is substantially cylindrical. An axial through hole 413 is defined in the piston 41. The piston 41 is sleeved on the rod body 31 via the through hole 413. Two connecting holes 415 are defined in an outer wall of the piston 41, corresponding to the two rotation grooves 315. Two axial sliding grooves 417 are defined in the outer wall of the piston 41, corresponding to the two connecting holes 117 defined in the cylinder body 11. Each axial sliding groove 417 is a slot. Two mounting rings 42 are sleeved on opposite ends of the piston 41, and resist against the inner wall of the cylinder body 11 in the receiving hole 111, respectively. The two rotation pins 43 pass through the two connecting holes 415, and then movably connect with the two rotation grooves 315, such that the cylinder rod 30 and the piston 41 are rotatably mounted together. The two sliding pins 45 pass through the two connecting holes 117, and then movably connect with the two axial sliding grooves 417, such that the piston 41 and the cylinder body 11 are slidably mounted together, and the piston 41 is capable of axial movement relative to the cylinder body 11.

The guiding sleeve 50 is hollow and cylindrical. The guiding sleeve 50 is sleeved on a distal end of the rod body 31 away from the flange portion 33, and is received in the mounting groove 153 defined in the top cover 15, such that the cylinder rod 30 is rotatably connected with the top cover 15.

The connection assembly 70 includes a sleeve 71, two stop bearings 73, a support ring 75, and a support cover 77. The sleeve 71 is received in the receiving hole 111 of the cylinder body 11 adjacent to the bottom cover 13, and is sleeved on the cylinder rod 30. In the illustrated embodiment, the sleeve 71 is hollow and substantially cylindrical, and includes a first end 711 and a second end 713 opposite to the first end 711. An inner diameter of the first end 711 is greater than that of the semi-sealed second end 713. The inner diameter of the first end 711 is substantially the same as a diameter of the rod body 31, and smaller than a diameter of the flange portion 33, such that the sleeve 71 is prevented from sliding out from the end of the cylinder rod 30 adjacent to the flange portion 33. One of the two stop bearings 73 is sleeved on the end of the cylinder rod 30 adjacent to the flange portion 33, and is positioned on the second end 713 of the sleeve 71. The support ring 75 is mounted in the sleeve 71, and resists against the flange portion 33 and one of the stop bearings 73. The support cover 77 is mounted in the first end 711 of the sleeve 71, and assembled with the bottom cover 13 and the other stop bearing 73. The other stop bearing 73 is received in the mounting groove 135. In the illustrated embodiment, the support cover 77 is a substantially circular plate. A circular receiving groove 773 is defined in an end surface of the support cover 77. A cylindrical protrusion 775 is formed in the other end surface of the support cover 77 opposite to the end surface of the support cover 77 defining the receiving groove 773. The receiving groove 773 and the protrusion 775 are formed on a center portion of the support cover 77.

The elastic member 90 is received in the cylinder body 11. One end of the elastic member 90 is inserted into the mounting hole 313 of the cylinder rod 30, and resists against the inner bottom wall of the cylinder rod 30 in the mounting hole 313. The other end of the elastic member 90 is inserted into the receiving groove 773 of the support cover 77, and resists against the bottom wall of the receiving groove 773. The elastic member 90 is a compression spring in the illustrated embodiment.

In assembly, the bottom cover 13 and the sealing washer 16 sleeved on the bottom cover 13 are mounted in the end of the cylinder body 11 away from the fixing hole 119, and the latching ring 17 is latched in the annular latching groove 114, such that the bottom cover 13 is fixed to one end of the cylinder body 11, sealing one end of the cylinder body 11. The support cover 77 and one of the stop bearings 73 are mounted in the cylinder body 11, and are rotatably connected to the bottom cover 13. The stop bearing 73 is received in the mounting groove 135 and sandwiched between the bottom cover 13 and the support cover 77. The connection assembly 70 and the elastic member 90 are mounted on the end of the rod body 31 adjacent to the flange portion 33; then the connection assembly 70, the elastic member 90, and the cylinder rod 30 are inserted axially into the cylinder body 11, and the end of the rod body 31 away from the flange portion 33 protrudes out from the cylinder body 11. The sleeve 71 is securely mounted in the receiving hole 111 and sleeved on the flange portion 33. The stop bearings 73 are oppositely mounted in the sleeve 71, one stop bearing 73 being adjacent to the first end 711 and the other stop bearing 73 adjacent to the semi-sealed second end 713. The stop bearing 73 adjacent to the second end 713 is sleeved on the flange portion 33, and is mounted with the support ring 75. The other stop bearing 73 and the support cover 77 are mounted in the first end 711 and rotatably connected with the bottom cover 13. The piston 41 is sleeved on the rod body 31 and received in the receiving hole 111, and the two mounting rings 42 sleeved on the piston 41 are received in the receiving hole 111. The two rotation pins 43 pass through the two connecting holes 415, and movably connect with the two rotation grooves 315, such that the cylinder rod 30 and the piston 41 are rotatably mounted together. The two sliding pins 45 pass through the two connecting holes 117, and movably connect with the two axial sliding grooves 417, such that the piston 41 and the cylinder body 11 are slidably mounted together, and the piston 41 is capable of sliding axially relative to the cylinder body 11. The top cover 15, the other sealing member 16 sleeved on the top cover 15, and the guiding sleeve 50 received in the mounting groove 153 are mounted in the other end of the cylinder body 11 away from the bottom cover 13, and are movably sleeved on the other end of the rod body 31 away from the flange portion 33. The other latching ring 17 is latched in the annular latching groove 114 to prevent the top cover 15 from sliding out from the cylinder body 11. Finally, the adjusting valves 18 are connected to the inlet 113 and the outlet 115 of the cylinder body 11, to complete the assembly of the cylinder 100.

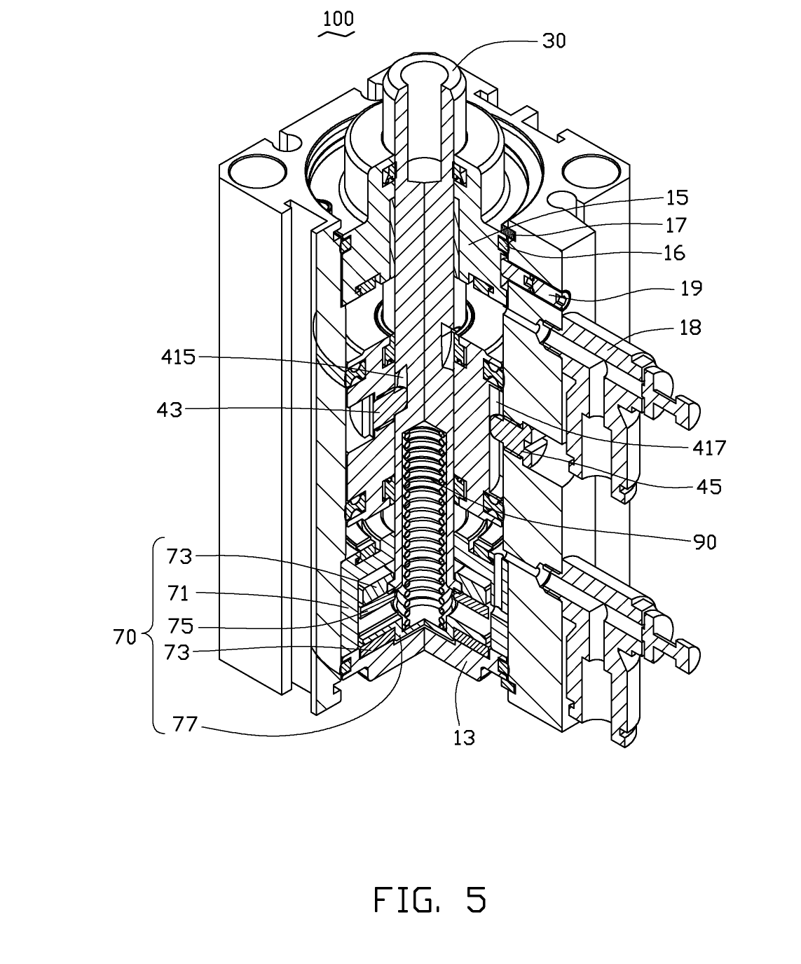

Referring also to FIG. 5, in use, the adjusting valves 18 are connected to two gas sources, to introduce gases into the cylinder body 11. In an initial state, the piston assembly 40 stays at the top end of the cylinder body 11 adjacent to the top cover 15. When the gas under pressure flows into the cylinder body 11 via the inlet 113, the piston 41 is pushed toward the bottom cover 13 along the sliding grooves 417 relative to the cylinder body 11, and the rotation pins 43, which interconnect the piston 41 and the cylinder rod 30, slide along the rotation grooves 315 such that the cylinder rod 30 is driven to rotate relative to the piston 41. In this sliding process of the rotation pins 43, because the sliding pins 45 are fixed to the cylinder body 11, the piston 41 thus slides only along the axial direction of the cylinder body 11. Until the cylinder rod 30 reaches its radial movement limit relative to the piston 41, the piston 41 and the cylinder rod 30 slide axially toward the bottom cover 13 by the exerted force from the gas pressure, the elastic member 90 is compressed, and the sliding pins 45 slide axially toward the bottom cover 13. The pressurized gases flow into the cylinder body 11 via the outlet 115 until the sliding pins 45 slide to a distal end of the axial sliding groove 417 adjacent to the bottom cover 13, such that the piston 41 together with the cylinder rod 30 slide toward the top cover 15 under an elastic axial force of the elastic member 90, the rotation pins 43 slide along the rotation grooves 315 toward the top cover 15, and thereby the cylinder rod 30 rotates in reverse direction relative to the piston 41.

The rotation grooves 315 are defined in the cylinder rod 30, and the piston 41 and the cylinder rod 30 are connected together via the rotation pins 43; and the sliding grooves 417 are defined in the piston 41, and the piston 41 and the cylinder body 11 are connected together via the sliding pins 45. Therefore, the piston 41 is capable of sliding axially relative to the cylinder body 11 and rotating around the axis relative to the cylinder rod 30. With such a simple structure, the cylinder 100 is capable of driving other devices which require rotational as well as lateral movement.

In other embodiments, the quantities of the connecting holes 117, the rotation grooves 315, the sliding grooves 417, and the connecting holes 415 can be changed as needed, such as one, or more than two. The quantities of the rotation pins 43 and the sliding pins 45 can change accordingly.

While various embodiments have been described and illustrated, the disclosure is not to be construed as being restricted thereto. Various modifications can be made to the embodiments by those skilled in the art without departing from the true spirit and scope of the disclosure as defined by the appended claims.

What is claimed is:

1. A cylinder, comprising:
a cylinder body assembly comprising a cylinder body, the cylinder body defining a receiving hole, an inlet, and an outlet, the inlet and the outlet communicating with the receiving hole;
a piston assembly comprising a piston movably mounted in the receiving hole of the cylinder body along an axial direction thereof, and at least one rotation pin; and
a cylinder rod movably mounted in the receiving hole of the cylinder body assembly, wherein a rotation groove is defined in the cylinder rod, the piston is sleeved on the cylinder rod via the at least one rotation pin, one end of the at least one rotation pin is connected to the piston, and the other end of the at least one rotation pin is movably connected in the rotation groove, such that the cylinder rod is rotatably connected with the piston, and is rotatable relative to the piston and the cylinder body driven by the at least one rotation pin.

2. The cylinder of claim 1, wherein the cylinder further comprises a guiding sleeve and a connection assembly, the guiding sleeve is mounted in one end of the receiving hole of the cylinder body and sleeved on one end of the cylinder rod, and the connection assembly is mounted in the other end of the receiving hole of the cylinder body and sleeved on the other end of the cylinder rod.

3. The cylinder of claim 1, wherein the cylinder further comprises an elastic member mounted in the receiving hole of the cylinder body, one end of the elastic member resists against the connection assembly, and the other end of the elastic member resists against one end of the cylinder rod adjacent to the connection assembly.

4. The cylinder of claim 3, wherein the cylinder body assembly further comprises a bottom cover and a top cover, the receiving hole is defined in the cylinder body along an axial direction thereof, two annular mounting grooves are respectively defined in an inner wall of the cylinder body at opposite ends of the receiving hole, and the bottom cover and the top cover are respectively air-tightly mounted in the two annular mounting grooves.

5. The cylinder of claim 4, wherein a shaft hole is defined in a center portion of the top cover along an axial direction thereof, an annular mounting groove is defined in an inner wall of the top cover at one end of the shaft hole, the mounting groove is coaxial with the shaft hole, the guiding sleeve is received in the mounting groove, the cylinder rod comprises a rod body and a flange portion extending from one end of the rod body, the rotation groove is defined in the rod body, the connection assembly is sleeved on one end of the rod body adjacent to the flange portion, and the other end of the rod body passes through the guiding sleeve, rotatably connects to the top cover, and protrudes out from the shaft hole and the receiving hole.

6. The cylinder of claim 4, wherein the inlet and the outlet are defined in an outer wall of the cylinder body, communicating with the receiving hole, the cylinder body assembly further comprises two adjusting valves connected to the inlet and the outlet, respectively.

7. The cylinder of claim 4, wherein at least one connecting hole is defined in the cylinder body communicating with the receiving hole, at least one axial sliding groove is defined in the piston along the axial direction thereof, the piston assembly further comprises at least one sliding pin, the at least one sliding pin passes through the at least one connecting hole and movably connects with the at least one sliding groove, such that the piston and the cylinder body are slidably connected together, and the piston is sliding along the axial direction relative to the cylinder body.

8. The cylinder of claim 5, wherein the connection assembly further comprises a sleeve, two stop bearings, a support ring, and a support cover, the sleeve is rotatably connected to the flange portion of the cylinder rod via one of the stop bearings and the support ring, and the support cover is rotatably connected to the bottom cover via the other stop bearing and spaced from the flange portion of the cylinder rod in the axial direction, and the elastic member is sandwiched between the cylinder rod and the support cover.

9. The cylinder of claim 5, wherein a mounting hole is defined in an end surface of the rod body adjacent to the flange portion along the axial direction thereof, a receiving groove is defined in the support cover; and one end of the elastic member inserts into the mounting hole of the cylinder rod, and resists against an inner bottom wall of the cylinder rod in the mounting hole, and the other end of the elastic member inserts into the receiving groove of the support cover, and resists against a bottom wall of the receiving groove, such that the cylinder rod is capable of sliding toward the bottom cover along the axial direction thereof.

10. The cylinder of claim 4, wherein an annular latching groove is defined in an inner wall of each annular mounting groove adjacent to the end of the cylinder body; the cylinder body assembly further comprises two latching rings; and each of two latching rings is latched in a corresponding annular latching groove, and the bottom cover and the top cover are respectively latched by the two latching rings to prevent from sliding out from the cylinder body.

11. The cylinder of claim 2, wherein the cylinder further comprises an elastic member mounted in the receiving hole of the cylinder body, opposite ends of the elastic member respectively resist against the connection assembly and one end of the cylinder rod adjacent to the connection assembly.

12. A cylinder, comprising:
a cylinder body assembly comprising a cylinder body, the cylinder body defining a receiving hole, an inlet, and an outlet, the inlet and the outlet communicating with the receiving hole;
a piston assembly comprising a piston movably mounted in the receiving hole of the cylinder body along an axial direction thereof, and a rotation pin;
a cylinder rod movably mounted in the receiving hole, wherein a rotation groove is defined in the cylinder rod, the piston is sleeved on the cylinder rod via the rotation pin, one end of the rotation pin is connected to the piston, and the other end of the rotation pin is movably connected in the rotation groove, such that the cylinder rod is rotatably connected with the piston, and is rotatable relative to the piston and the cylinder body driven by the rotation pin;
a guiding sleeve;
a connection assembly, wherein the guiding sleeve and the connection assembly are respectively mounted in opposite ends of the receiving hole of the cylinder body, and are respectively sleeved on opposite ends of the cylinder rod; and
an elastic member mounted in the receiving hole of the cylinder body, wherein opposite ends of the elastic member respectively resist against the connection assembly and one end of the cylinder rod adjacent to the connection assembly.

13. The cylinder of claim 12, wherein the cylinder body assembly further comprises a bottom cover and a top cover, the receiving hole is defined in the cylinder body along an axial direction thereof, two annular mounting grooves are respectively defined in an inner wall of the cylinder body at opposite ends of the receiving hole, and the bottom cover and the top cover are air-tightly mounted in the two annular mounting grooves, respectively.

14. The cylinder of claim 13, wherein a shaft hole is defined in a center portion of the top cover along an axial direction thereof, an annular mounting groove is defined in an inner wall of the top cover at one end of the shaft hole, the mounting groove is coaxial with the shaft hole, the guiding sleeve is received in the mounting groove, the cylinder rod comprises a rod body and a flange portion extending from one end of the rod body, the rotation groove is defined in the rod body, the connection assembly is sleeved on one end of the rod body adjacent to the flange portion, and the other end of the rod body passes through the guiding sleeve, rotatably connects to the top cover, and protrudes out from the shaft hole and the receiving hole.

15. The cylinder of claim 13, wherein the inlet and the outlet are defined in an outer wall of the cylinder body, communicating with the receiving hole, the cylinder body assembly further comprises two adjusting valves connected to the inlet and the outlet, respectively.

16. The cylinder of claim 13, wherein a connecting hole is defined in the cylinder body communicating with the receiving hole, a sliding groove is defined in the piston along the axial direction thereof, the piston assembly further comprises a sliding pin, the sliding pin passes through the connecting hole and movably connects with the sliding groove, such that the piston and the cylinder body are slidably connected together, and the piston is sliding along the axial direction relative to the cylinder body.

17. The cylinder of claim 14, wherein the connection assembly further comprises a sleeve, two stop bearings, a support ring, and a support cover, the sleeve is rotatably connected to the flange portion of the cylinder rod via one of the stop bearings and the support ring, and the support cover is rotatably connected to the bottom cover via the other stop bearing and spaced from the flange portion of the cylinder rod in the axial direction, and the elastic member is sandwiched between the cylinder rod and the support cover.

18. The cylinder of claim 14, wherein a mounting hole is defined in an end surface of rod body adjacent to the flange portion along the axial direction of the rod body, a receiving groove is defined in the support cover; and one end of the elastic member inserts into the mounting hole of the cylinder rod, and resists against an inner bottom wall of the cylinder rod in the mounting hole, and the other end of the elastic member inserts into the receiving groove of the support cover, and resists against a bottom wall of the receiving groove, such that the cylinder rod is capable of sliding toward the bottom cover along the axial direction thereof.

19. The cylinder of claim 13, wherein an annular latching groove is defined in an inner wall of each annular mounting groove adjacent to the end of the cylinder body; the cylinder body assembly further comprises two latching rings; and each of two latching rings is latched in a corresponding annular latching groove, and the bottom cover and the top cover are respectively latched by the two latching rings to prevent from sliding out from the cylinder body.

20. The cylinder of claim 12, wherein the cylinder further comprises an elastic member mounted in the receiving hole of the cylinder body, opposite ends of the elastic member resist against the connection assembly and one end of the cylinder rod adjacent to the connection assembly, respectively.
